(19) United States
(12) Patent Application Publication
(10) Pub. No.: US 2007/0046594 A1
(43) Pub. Date: Mar. 1, 2007

(54) Optical shutter for a display apparatus comprising an array of switches

(76) Inventor: Nicholas F. Pasch, Pacifica, CA (US)

Correspondence Address: Trellis Intellectual Property Law Group, PC, 1900 EMBARCADERO ROAD, SUITE 109, PALO ALTO, CA, 94303, US

(21) Appl. No.: 11/485,060

(22) Filed: Jul. 11, 2006

Related U.S. Application Data
(63) Continuation-in-part of application No. 60/711,704, filed on Aug. 26, 2005.

(51) Int. Cl. G09G 3/34

(52) U.S. Cl. 345/84

(57) ABSTRACT

A class of electromechanical switch cell including an optical shutter mechanism suited for use as an optical light valve, light curtain, and/or other display applications, is disclosed. An optical shutter in accordance with embodiments of the present invention can include a first set of opaque elements on a substrate foil and a second set of opaque elements on an opposing surface of a moveable foil. By translating the moveable foil, the second set of opaque elements can be made to alternatively be in optical misalignment with the first set of opaque elements, in which case light may not pass through the cell, or in optical alignment with the first set, in which case light may pass through the cell.

### REFERENCE TO RELATED APPLICATIONS

This application claims the benefit of U.S. Provisional Application No. 60/711,704, filed Aug. 26, 2005 (Attorney Docket No. 100115-001300US), which is incorporated herein by reference in its entirety.

### BACKGROUND OF THE INVENTION

1. Field of the Invention

Embodiments of the present invention relate to a display apparatus. More particularly, embodiments of the present invention relate to an optical shutter for pixels in a display.

2. Description Of The Background Art

A flexible array of micro-electromechanical switches (e.g., FASwitch™ switches) includes advantages, such as low cost and the ability to adapt the array to a variety of uses. By way of example, the array of switches can be adapted for printer applications, as a wearable display, as an annunciator, as a component of electronic paper, or as the backplane for a variety of optical displays.

Optical displays, such as liquid crystal displays (“LCDs”), plasma displays and organic light emitting displays (OLEDs), electro-luminescent displays, electronic ink paper displays, and other pixel-based displays are used in many products, such as computer displays, cellular telephones, flat screen televisions, watches, entertainment devices, microwave ovens and many other electronic devices.

To reduce the cost and to provide novel capabilities associated with many display applications, FASwitch™ switches can include a class of flexible microelectromechanical system (MEMS) devices or switch arrays that may be created from relatively inexpensive polymer foils. The switch cell design preferably uses electrostatic attraction to pull the polymer foils together to achieve an ON state and may use the elastic energy stored in the stretched polymer film to return the switch to the OFF state. The use of both mechanical and electrostatic force to change the state of the switch has many advantages, including relatively low cost drive circuitry and simple manufacturability. However, an optimal solution of the balancing of such electrostatic and mechanical forces sometimes compels a cell design with certain features, such as thin polymer foils, relatively large pixel pitch or narrow gaps between foils.

It will also be appreciated that some particular variations of FASwitch™ switch arrays may have relatively slow switching speed because of a reliance on mechanical force to return the switch to the OFF state. Further, maintaining the tolerance of the spacing between foils across the array may be difficult because a moveable membrane must be maintained under tension very close to an associated non-moveable membrane. Thus, it has been discovered that there is a great need for a switch array where the movable membrane of the switch, while anchored to the structure is not under tension and that can be rapidly switched between the ON state and the OFF state.

Further, what is also desired is an improved mechanism that includes an optical shutter to control light emitted through a transparent area of a mask structure. In prior applications, controlling the emission of light a transparent area of a mask structure relied on a moving occultating disk. This optical design concept was well adapted to the FASwitch™ switch array where the moveable polymer foil is maintained under tension. However, a new optical shutter principle is required where the moveable polymer foil is not maintained under tension.

Accordingly, there is a need for an apparatus that incorporates a switch array that addresses the known areas of existing switch cell technology where improvement is desired.

### BRIEF DESCRIPTION OF THE DRAWINGS

FIGS. 1 and 2 illustrate a sectional side view of an exemplary cell in the OFF state and the ON state, respectively, where the movable foil does not rely on mechanical force to control the action of the cell, in accordance with embodiments of the present invention.

FIG. 3 is a sectional side view of an optical shutter in an exemplary cell in accordance with embodiments of the present invention where the cell is in the OFF state.

FIG. 4 is a sectional side view of the optical shutter in the exemplary cell in accordance with embodiments of the present invention where the cell is in the ON state.

FIG. 5 is a top view of the substrate foil in the exemplary cell in accordance with embodiments of the present invention.

FIG. 6 is a bottom view of the movable foil in the exemplary cell showing the opposing surface with respect to the substrate foil in accordance with embodiments of the present invention.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. However, embodiments of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

In accordance with embodiments of the present invention, an array of mechanical switches may be controlled by row/column electrodes that are accessible by drivers similar in operation to ones currently used in conventional optical displays. The array may be used to create nonlinear voltage and/or current switching responses that are applied or impressed on the optical cells of the display to generate an image. Other types of display technologies or electrical design or fabrication techniques can be used in conjunction with those specific technologies, designs or techniques described herein. For example, features of the microelectromechanical (MEM) switching approach can be used with any type of actuator, switch, chemical or physical device or property, etc., to cause an effect suitable for imaging in an optical display. In general, any type of suitable driver or drive signal can be used in accordance with embodiments.

An example of a FASwitch™ switch cell where the moveable polymer foil is maintained under tension has been previously disclosed in a utility patent application entitled “MICRO-ELECTROMECHANICAL SWITCHING BACKPLANE” by Michael D. Sauvante, et al., application Ser. No. 10/959,604, filed on Oct. 5, 2004, the disclosure of which is incorporated herein for all purposes.

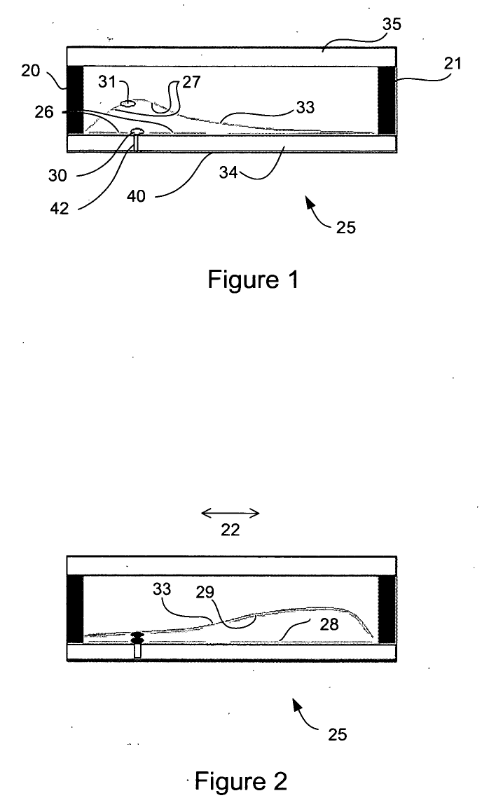

Referring now to the drawings more particularly by reference numbers, an exemplary cell in accordance with embodiments of the present invention is shown in FIGS. 1 and 2.

One embodiment of the present invention can provide a class of MEMS switch cells that may improve the frequency that the cells can be switched from the ON state to the OFF state. More specifically, the movable membrane of the switch may be anchored to the cell structure, but the movable membrane may not be under tension. Electrostatic attraction can be used to pull the moveable membrane into both the ON state and the OFF state position. Thus, this class of MEMS switch cells may have a significantly improved switching speed.

Because of the movable membrane of the switch not being under tension, this class of MEMS switch cells may be more tolerant of variations in manufacturing tolerances, as compared to other approaches. Specifically, the class of MEMS switch cells can be significantly less sensitive to the planarity of the substrate membrane or to the spacing between the substrate membrane and the movable membrane. Further, the class of MEMS switch cells may have a smaller pitch from one cell to another cell and thus may be significantly optimized for use in displays. Since both the substrate and the movable membrane can be made of polymer foil, the array of MEM switches is flexible, thereby enabling a wide range of possible applications.

Further, another embodiment of a class of switch cells may not store elastic energy in the flexible foil. Rather, in accordance with embodiments of the present invention, a movable foil may be electrostatically pulled from the ON state to the OFF state, and vice versa. Advantageously, there may be no requirement for balancing the electrostatic and mechanical energies, as may be required when the flexible foil is held in tension, as discussed above. As is understood by those skilled in the art, other means of attracting the movable foil may be used in lieu of electrostatic force. For example, magnetic, magnetorestrictive, electromagnetic, or other means of generating attractive or repulsive forces may be used in accordance with embodiments of the present invention.

Because this class of switch cell designs may require separate drive electronics for pulling the movable foil into either the ON state or the OFF state, but also because the pull is not against a tensioned foil, the amount of power needed for the switch transition can be much reduced, as compared to other approaches. Specifically, in accordance with embodiments of the present invention, there may be no need to apply a high voltage holding force to the switch to oppose the mechanical force created when the flexible foil is in the ON state. This power reduction can be used either to reduce the total power of the switch array, or the reduction can be used to speed up the switching speed of the display. Either is highly desirable, depending on the particular display application.

In accordance with embodiments of the present invention, a flexible layer that is not under tension may characterize this class of switch cells. An exemplary cell structure (a “wave” cell) is shown in FIGS. 1 and 2 (see general reference character 25). The exemplary wave cell may use electrostatic attraction between polymer foils that are maintained in close proximity. In this way, the magnitude of the electrostatic attraction force necessary to change the cell from one state to another can be minimized. Also, the cell can have lower gas-elastic dampening, as compared to other designs, thus allowing for faster switching times. Further, the cell design can include relatively relaxed manufacturing tolerances in terms of spacing between layers, substrate planarity, and cell pitch, for example.

In addition to drive circuitry for controlling voltage applied to contacts 30 and 31, drive circuitry for controlling the voltage applied across plates 26, 27, 28 and 29 can be included in accordance with embodiments of the present invention. Drive circuitry for controlling plates 26 and 27 can operate in conjunction with drive circuitry for controlling plates 28 and 29 to actively pull foil 33 into the OFF state. In one exemplary operation, the plate drive circuitry may be coordinated so that, as voltage is applied to controlling plates 26 and 27, voltage may be simultaneously removed from controlling plates 28 and 29, and vice versa. However, if both sets of drive circuits are active at substantially the same time, tension can be applied to foil 33 to a desirable amount such that many of the manufacturing and environmental effects that could cause operation variations can be largely eliminated. Essentially, the operation of the exemplary wave cell may use substantially the same ON side drive scheme as other related approaches. For example, the OFF state may be driven by a separate circuit, but the drive voltage can be coordinated with the ON state drivers. The drive circuitry can electrostatically pull the cell into a desired state or otherwise regulate the tension in foil 33 during operation.

With reference now to FIG. 1, substrate 34 may contain the display power plate 40 on its front surface. Power plate 40 can directly connect to a chosen display media, and may include various metals (e.g., Cu, Al, Ni, Ag, Au, and others) or metal sandwiches. Power plate 40 may also include conductive traces having conductive organic materials or metal loaded conductive ink materials, for example. A conductive via structure 42 may be formed between the front surface of substrate 34 and its back surface. This via structure can bring the electrical energy to the display media 40 from the switching contacts of the switch cell. As will be apparent to one of ordinary skill in the art, substrate 34 may also include an added electrostatic plate that can latch the switch contact in an ON state. The side of movable foil 33 facing substrate 34 in this particular example can include one, two, or more electrostatic plates disposed across rows of the array. In accordance with embodiments of the present invention, a flexing of foil 33 can occur so that a bulge or “wave” is created in the foil as it changes state.

In operation, display driver circuitry can activate the electrostatic plate on foil 33 and then either the ON or OFF electrostatic plate on substrate 34. The wave structure in foil 33 may traverse away from the opposing electrostatic plates that are attracting each other. Further, a latching plate structure can be incorporated into substrate 34. In addition, contacts 30 and 31 may be removed from the cell for use in optical shutter arrangements in accordance with embodiments of the present invention.

Further, foil 33 may only be attached to support structures 20 and 21, which in turn may define the pitch of the pixel. Support structures 20 and 21 can extend in the Z-direction or perpendicular to the plane of the paper in FIG. 1. Also, foil 33 may be attached along only two edges within the cell. If desired, additional support structures may be provided along the length of a cell, but foil 33 may not be attached or coupled to such additional supports. Of course, foil 34 (substrate foil) and foil 35 (secondary substrate foil) may be attached or coupled to these additional support structures in some applications.

A change in state is illustrated in FIG. 2, as power may be alternatively applied to plates 26 and 27, and to plates 28 and 29. Advantageously, this change in state may occur relatively quickly because there may be little or no gas to move out of the cell, there may be no mechanical de-bounce time associated with a change in state, and the distance that must be traversed by foil 33 can be minimized. As shown, a maximum spacing between foil 33 and substrate foil 34 may be substantially displaced along reference axis 22 when switching between states. Thus, in operation, foil 33 may traverse along substrate foil 34 when electrostatic forces are applied to the respective plate pairs (plates 26 and 27, and plates 28 and 29).

In accordance with embodiments of the present invention, drive circuitry for controlling the voltage applied across plates 26, 27, 28 and 29 may be included. Drive circuitry for controlling plates 26 and 27 can operate substantially in conjunction with drive circuitry for controlling plates 28 and 29 to change the state of the switch. In operation, display driver circuitry can activate the electrostatic plates on foil 33 and then the corresponding opposing plate on substrate 34, for example. The wave structure in foil 33 can traverse away from the opposing electrostatic plates that are attracting each other.

Plates 26, 27, 28 and 29 can be formed of various metals (e.g., Cu, Al, Ni, Ag, Au, and others) or metal sandwiches. The plates can also include conductive traces having conductive organic materials, indium tin oxide (ITO), or metal loaded conductive ink materials, for example.

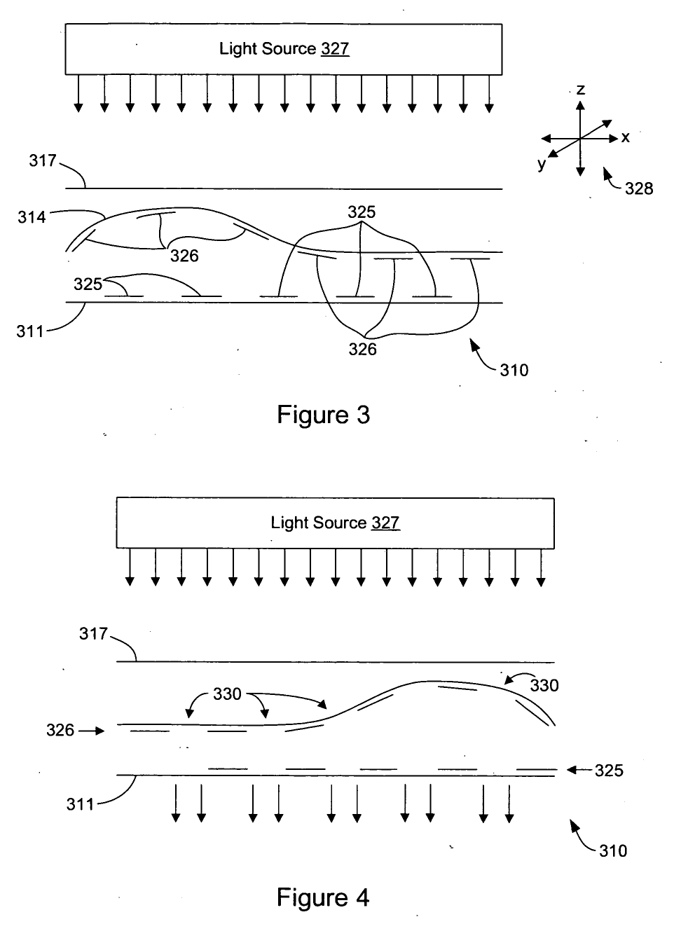

Referring now to FIG. 3, a sectional side view of an optical shutter in an exemplary cell in accordance with an embodiment of the present invention is shown. The optical shutter can include a first set of opaque elements 325 on substrate foil 311 and a second set of opaque elements 326 on the opposing surface of foil 314. In the illustrated state, the first set of opaque elements 325 may not be optically aligned with the second set of opaque elements, thereby substantially preventing the transmission of light from light source 327 through cell 310.

Referring now to FIG. 4, a sectional side view of the optical shutter when the state of the cell is changed to allow light to pass through transparent areas 330 in the cell 310. Light can pass through cell 310 because the first set of opaque elements 325 may be in optical alignment with the second set of opaque elements 326. Thus, at least a portion of the light passing from light source 327 can passed through the transparent areas of cell 310, as shown.

If a coordinate system 328 is defined such that the foils included in cell 310 are disposed in respective XY planes, then the displacement of flexible foil 314 may be in the positive Z direction. The Z direction can also include the optical axis of the display. A consequence of a change in state of cell 310 is that there can be a displacement of the flexible foil in the X direction, as well as a Z direction displacement. The magnitude of the X displacement may be related to the gap between substrate foil 311 and secondary substrate foil 317. Further, because cell 310 does not depend on the elastic relaxation of flexible foil 314 to change the state of the cell, the spacing between foils 311 and 317 tends to be tolerant of a wide variation. Thus, the increased spacing of these layers may permit a substantial displacement of foil 314 along the X-axis when changing state.

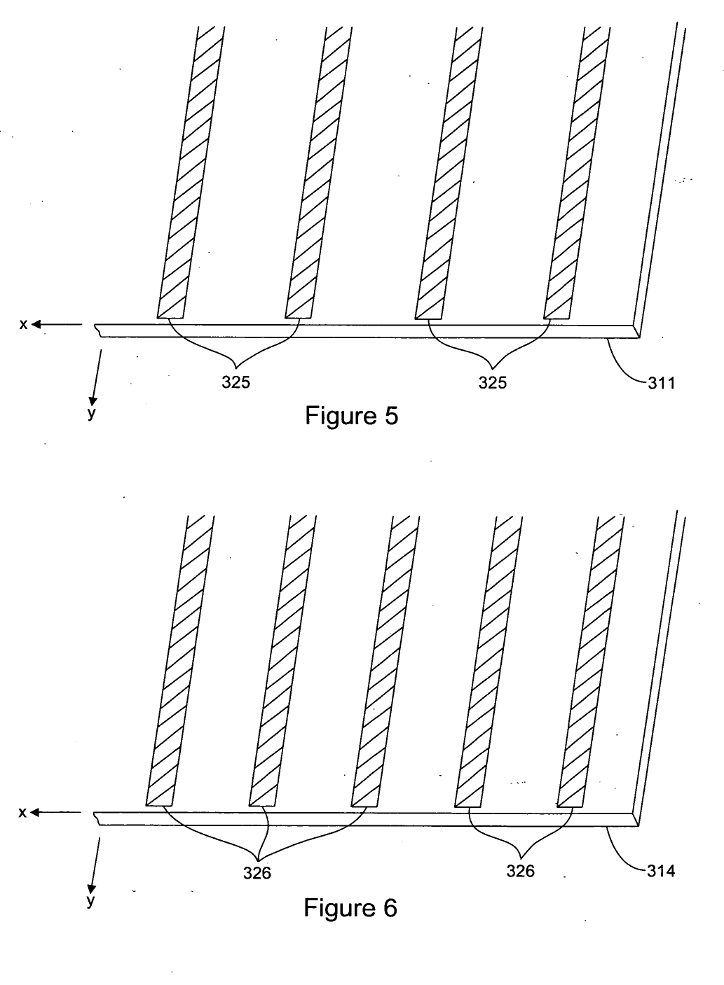

As illustrated in FIGS. 5 and 6, the optical shutter elements each have a pattern of alternating clear areas and opaque areas that may be created on the inside of the cell on either or both of substrate layer 311 and/or the secondary substrate layer 317. This pattern may be interrupted by the placement of electrostatic plates, or may even be part of the pattern of electrostatic plates, for example. Each opaque area may be an elongated stripe disposed along the Y-axis of the foil. The width of the stripe pattern in the X direction can be related to the spacing of layers used to form cell 310, but this can depend on the specific cell variation and/or the particular application for which the cell is designed.

The optical shutter can also include an alternating series of clear and opaque areas disposed on flexible foil 314, as illustrated in FIG. 6. As above, this pattern may be interrupted by electrostatic plates and the alternating pattern may be part of some portion of the electrostatic plates. As with the stripe pattern on substrate foils 311 and/or 317, the long axis of the opaque stripe area may be parallel to the Y axis. The spacing of the stripes on foil 314 can substantially equal that of the spacing of the stripes in the substrate foil, for example.

When the cell is assembled, there may be a specific relationship of the attachment points of the flexible foil 314 relative to the substrate foils 311 and/or 317. The attachment of flexible foil 314 to the substrate foils 311 and/or 317 in the minus X direction of the cell can have the opaque strips of the flexible foil 314 substantially overlapping the opaque strips of the substrate foils 311 and/or 317. In the plus X direction of the cell, the flexible foil 314 attachment to the substrate foils 311 may be so disposed such that the opaque strips of the flexible foil 314 can substantially overlap the transparent strips of the substrate foils 311 and/or 317. The slack of the flexible foil 314 can accommodate the relative displacement. Also, foil 317 can have at least one more stripe than the corresponding foil 311 or 317. Further, foil 317 can be longer than foil 311 and/or foil 317 by at least one stripe in the x-direction, for example.

In operation, most of the flexible foil 314 may be in registration with either the minus X or the plus X side of the cell. If the cell is turned ON, the flexible foil 314 can be pulled into registration with the minus X side of the cell and light can stream through the clear stripes of the foils. On the other hand, if the cell is turned OFF, then the flexible foil 314 displacement in the positive X direction may cause the opaque stripes to line up in a staggered fashion and little light can escape through the cell.

In accordance with embodiments of the present invention, due to the increased switching speed afforded by the low-tension cell design discussed above, an array of switches having optical shutters may be utilized in control of a display media at rates consistent with those of full motion video. Also in accordance with embodiments of the present invention, a display or light curtain can include two sets of interfaces: one set electrical and one set optical. The electrical interfaces may include electrostatic plates that are substantially parallel to the rows of the display on one of the foils and electrostatic plates that are substantially parallel to the columns of the display on one or more of the other foils.

The optical elements may depend on the specific implementation of the display, and whether it is to be a transmissive, transflective, or reflective type of display. In the particular examples described above, it is a transmissive display with a light source disposed on the back-side of foil 317, for example. As such, the viewer is assumed to be on the front side (+Z) of the substrate foil 311.

In one aspect of embodiments of the present invention, silicon-on-glass thin film transistors (TFT) based backplanes can be replaced with a matrix of MEM switches that are readily manufactured using inexpensive manufacturing equipment and printing process techniques. Further, in another aspect of embodiments of the present invention, the manufacture of scalable large optical displays on rigid or flexible plastic membranes at relatively low cost, but that have an adequate and useful lifetime, can be enabled. Further still, in another aspect of embodiments of the present invention, the manufacture of optical displays that may be flexed and/or twisted into novel shapes, while still substantially maintaining the display properties, can be enabled.

There are many existing products, and potentially a large number of new products, that can benefit from an array of switches laid out in matrix pattern. Such a matrix pattern can be sometimes uniform, and sometimes not, depending on the particular application. In accordance with embodiments of the present invention, the opened (or closed) switch can be utilized to activate a variety of devices suitable for applications so needing such a switch.

In accordance with embodiments of the present invention, the array switches may include one or more of the following attributes: (i) may be physically scaled depending on the application; (ii) may switch either AC or DC voltages; (iii) may switch either high or low voltages; (iv) may switch high or low current; and/or (v) may include either a momentary or latched switch; or (vi) may incorporate not switching elements at all. The most common need for such an array today is for flat panel displays to replace the relatively expensive backplane based on silicon transistors layered onto glass substrates.

It will further be appreciated that one or more of the elements depicted in the drawings/figures can also be implemented in a more separated or integrated manner, or even removed or rendered as inoperable in certain cases, as is useful in accordance with a particular application.

Although the invention has been described with respect to specific embodiments thereof, these embodiments are merely illustrative, and not restrictive of the invention. For example, although the invention has been discussed primarily with respect to a two-dimensional array, many other configurations or arrangements are possible. In other embodiments, it may be desirable to use other than row/column driver addressing; such as where a concentric circular arrangement is used, a random arrangement, etc. A configuration can be multi-dimensional, as where two or more cells are stacked vertically so that a pixel can be defined by multiple (e.g., red, green and blue) independent display elements. Naturally, in such a stacked configuration the cells on top should be transmissive to light emitted or reflected by underlying cells.

Although the invention has been discussed with respect to a display system, other applications are possible. For example, the array of cells can be applied with electrostatic fields by laser, electron beam or other particle or energy beam, pressure, etc., similar to technologies used in imaging systems (e.g., copiers, charge coupled devices, dosimeter, etc.) or other systems. In such an application, the driver circuitry can be replaced with sensing circuitry to detect whether a cell is in an open or closed position. Thus, a sensing array can be achieved.

Functionality similar to that discussed herein may be obtained with different configurations and arrangements, sizes or combinations of components. Use of the term microelectromechanical (MEM) is not intended to limit the invention. Embodiments may use components of larger or smaller size than those described herein. In other designs, components may be omitted or added. For example, additional contact pads on either the non-pliable or flexible foils can be added. A different contact arrangement may also allow for only two contact surfaces rather than the three described herein. In other embodiments, both foils may be made flexible. Other variations are possible.

Other types of force than electrostatic may be used to bring foils into proximity. For example, electromagnetic, applied pressure (e.g., atmospheric or gaseous, liquid, solid), gravitational or inertial, or other forces can be used. Rather than use a force to bring two foils into proximity, another embodiment can have an un-energized state of foils in proximity (i.e., a closed switch state) and can use a force to cause the foils to be brought out of proximity (i.e., an open switch state). For example, an electrostatic force can be used to cause the foils to repel each other and break a contact connection.

Any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. In an array of microelectromechanical switch cells, each said switch cell comprising:
a substrate having at least one substrate drive plate;
a flexible foil maintained in a spaced apart relationship relative to said substrate such that said flexible foil is maintained at an angle relative to said substrate, said flexible foil having at least one drive plate opposing said substrate drive plate such that said drive plate and said substrate drive plate are positioned on a part of said flexible foil and said substrate, respectively, that has a less than maximum separation between said substrate and flexible foil; and
an optical shutter pattern configured with said substrate and said flexible foil.

2. The switch cell of claim 1, further comprising a secondary substrate positioned substantially parallel to said substrate.

3. The switch cell of claim 1, wherein a portion of said optical shutter pattern is positioned on said flexible foil as a plurality of opaque and clear areas.

4. The switch cell of claim 3, wherein a portion of said optical shutter pattern is positioned on said substrate as a plurality of complementary opaque and clear areas.

5. The switch cell of claim 4, wherein said plurality of opaque and clear areas on said flexible foil and said plurality of complementary opaque and clear areas on said substrate are optically aligned in one state and optically misaligned in another state.

6. The switch cell of claim 4, wherein said plurality of opaque areas comprise a plurality of stripes extend across said switch cell.

7. The switch cell of claim 1, configured to function as a light valve.

8. The switch cell of claim 1, configured to function as a light curtain.

9. The switch cell of claim 1, configured to function as a display.

10. The switch cell of claim 9, wherein said display comprises a full motion video display.

11. In an array of microelectromechanical switch cells configured as an optical shutter, each said switch cell comprising:
a substrate having at least one substrate drive plate and a substrate contact electrode; and
a flexible foil coupled to said substrate at substantially first and second ends, said flexible foil having a foil contact electrode and at least one drive plate opposing said substrate drive plate, said flexible foil being configured to have a position of a maximum spacing along said flexible foil relative to said substrate change in response to an operation of said drive plate and said substrate drive plate.

12. The switch cell of claim 11, further comprising:
a secondary substrate such that said flexible foil is positioned substantially between said substrate and said secondary substrate, said secondary substrate being positioned substantially parallel to said substrate; and
a light source disposed above said secondary substrate.

13. The switch cell of claim 12, further comprising at least one pair of opposing drive OFF plates, one of which is positioned on said flexible foil and one of which is positioned on said secondary substrate.

14. The switch cell of claim 13, wherein said pair of opposing drive OFF plates are operated in conjunction with said substrate drive plate to alternatively switch said switch cell between an ON state and an OFF state.

15. The switch cell of claim 14, wherein said ON state corresponds to an optical alignment of a plurality of opaque and clear areas on said flexible foil and a plurality of complementary opaque and clear areas on said substrate.

16. The switch cell of claim 15, wherein said OFF state corresponds to an optical misalignment of said plurality of opaque and clear areas on said flexible foil and said plurality complementary of opaque and clear areas on said substrate.

17. The switch cell of claim 11, configured to function as a light valve.

18. The switch cell of claim 11, configured to function as a light curtain.

19. The switch cell of claim 11, configured to function as a display.

20. A means for providing an optical shutter using an array of microelectromechanical switch cells, the means comprising:
a means for optically aligning and alternatively misaligning a plurality of opaque and clear surfaces disposed on a flexible foil with a plurality of complementary opaque and clear surfaces disposed on a substrate; and
a means for providing a light source to said array of micromechanical switch cells.
